(19) United States
(12) Patent Application Publication
(10) Pub. No.: US 2007/0248085 A1
(43) Pub. Date: Oct. 25, 2007

(54) Method and apparatus for managing hardware address resolution

(75) Inventor: Dennis Michael Volpano, Salinas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cranite Systems, Los Gatos, CA (US)

(21) Appl. No.: 11/595,418

(22) Filed: Nov. 9, 2006

Related U.S. Application Data
(60) Provisional application No. 60/735,622, filed on Nov. 12, 2005.

(51) Int. Cl. H04L 12/56

(52) U.S. Cl. 370/389

(57) ABSTRACT

Disclosed herein is a network device, such as a host computer, that simultaneously has two IP identities: a local IP identity on a local network (e.g., a non-virtual private network) to which the host computer is connected; and a remote IP identity on a second network (e.g., virtual private network) that is remote to the host. Only the remote IP identity is visible to the host operating system's network stack. Each IP identity has its own ARP cache and Address Resolution Protocol (ARP). The local ARP cache is managed with respect to a connection of the host to a local subnet (e.g., an Internet Service Provider (ISP) subnet) and the remote ARP cache is managed with respect to a remote subnet reachable through a gateway on the local subnet.

### CROSS-REFERENCES TO RELATED APPLICATIONS

This application claims priority to U.S. Provisional Application No. 60/735,622, filed Nov. 12, 2005 and is incorporated herein by reference in its entirety for all purposes.

### BACKGROUND OF THE INVENTION

The present invention relates to the Internet Protocol (IP) and more specifically to the routing of IP data. In particular, the present invention is directed to the management of hardware address resolution at a network interface.

The standard model for networking protocols and distributed applications is the International Standard Organization's Open System Interconnect (ISO/OSI) model. It defines the following seven network layers:

Layer 1—Physical

The physical layer defines the cable or physical medium itself, e.g., ethernet cables, unshielded twisted pairs (UTP), wireless links such as defined by the IEEE 802.
   Layer 2—Data Link
The data Link layer defines the format of data on the network. A network data frame, aka packet, includes checksum, source and destination address, and data. The data link layer handles the physical and logical connections to the packet's destination, using a network interface. A host connected to an Ethernet would have an Ethernet interface to handle connections to the network.
Ethernet addresses a host using a unique, 48-bit address called its Ethernet address or Media Access Control (MAC) address. MAC addresses are usually represented as six colon-separated pairs of hex digits, e.g., 8:0:20:11:ac:85. This number is unique and is associated with a particular Ethernet device. Hosts with multiple network interfaces should use the same MAC address on each. The data link layer's protocol-specific header specifies the MAC address of the packet's source and destination.
   Layer 3—Network
The Internetwork Protocol (IP) is responsible for routing, directing datagrams from one network to another. The Internetwork Protocol identifies each host with a 32-bit IP address. IP addresses are written as four dot-separated decimal numbers between 0 and 255, e.g., 129.79.16.40. The leading 1-3 bytes of the IP identify the network and the remaining bytes identifies the host on that network.
Even though IP packets are addressed using IP addresses, hardware addresses must be used to actually transport data from one host to another. The Address Resolution Protocol (ARP) is used to map the IP address to it hardware address.
   Layer 4—Transport
Two transport protocols, Transmission Control Protocol (TCP) and User Datagram Protocol (UDP), sit at the transport layer. TCP establishes connections between two hosts on the network through ‘sockets’ which are determined by the IP address and a port number. TCP keeps track of the packet delivery order and the packets that must be resent. UDP provides a lower overhead transmission service at the cost of less error checking capability.
   Layer 5—Session
The session protocol defines the format of the data sent over the connections. The Remote Procedure Call (RPC) is an example.
   Layer 6—Presentation
This layer converts a local representation of data to a canonical form and vice versa. The canonical form uses a standard byte ordering and structure packing convention, independent of the host.
   Layer 7—Application
This layer provides network services to the end-users. Email, ftp, telnet, DNS, NIS, NFS are examples of network applications.

An IP datagram includes a destination IP address indicating the IP address of the receiving network device. Transmission of an IP datagram from the source host to the destination host includes encapsulating the datagram in a data frame that is suitable for the physical medium of the network (e.g., an ethernet frame). The frame is then sent over the physical medium to the destination host.

The frame's destination address, however, is not the destination IP address contained in the IP datagram, but rather is the media access control (MAC) address of the network interface circuitry (also known as network adapter) at the destination host that is connected to the physical medium. For example, if the physical medium is Ethernet, then the network interface circuitry is an Ethernet card. As described above, ARP provides a mapping between an IP address that is assigned to a network device and a hardware address (MAC address) of the network interface circuit (e.g., ethernet card) installed in the network device. The destination MAC address is therefore determined from the destination IP address by a mapping that is maintained at the source.

The MAC address is a unique value associated with a network interface. MAC addresses are also known as hardware addresses or physical addresses. They uniquely identify an adapter on a LAN. MAC addresses are 12-digit hexadecimal numbers (48 bits in length). By convention, MAC addresses are usually expressed as:
MM:MM:MM:SS:SS:SS
   The first half of a MAC address (MM:MM:MM) contains the ID number of the adapter manufacturer. These IDs are regulated by an Internet standards body. The second half of a MAC address (SS:SS:SS) represents the serial number assigned to the adapter by the manufacturer.

A virtual private network (VPN) is a private communications network implemented on top of a publicly accessible network for private, confidential communication over the publicly accessible network. VPN messages can be carried over a public networking infrastructure (e.g., the Internet) using standard protocols (e.g., TCP/IP).

Typically, a third-party, remote-access VPN is implemented by a VPN virtual adapter on a client. The VPN adapter is a shim in the network protocol stack through which inbound and outbound network traffic passes. The shim may encrypt packets before they are sent through a physical interface to a network medium or decrypt packets that arrive at the physical interface from the medium. The VPN adapter and physical interface each has a distinct IP identity or address. The adapter has remote IP identity because its IP address is determined by a remote VPN gateway whereas the physical interface has local IP identity because its IP address is determined by the local ISP. FIG. 2 illustrates an example of a shim as embodied in accordance with the present invention.

A VPN gateway maintains a Security Policy Database for a client which prescribes rules for handling packets that traverse the VPN adapter on the client. In particular, the policy specifies which outbound packets from the client must enter the VPN tunnel. The destination IP address of a packet determines whether the packet must be encapsulated for transmission through the tunnel. Unfortunately, the policy is enforced by a mechanism outside the scope of the VPN, namely IP routing. A VPN client will configure the client's IP route table to reflect the VPN gateway's policy for outbound traffic. A packet that must traverse the VPN tunnel has a route indicating that the packet is routed via the remote IP identity, otherwise the packet is routed via the local IP identity. A weakness of this approach is that a Trojan on the client can modify the route table so that all outbound packets bypass the VPN tunnel and get transmitted via the local IP identity without the user ever knowing it. Packets that would normally be encrypted and sent over the tunnel now bypass the tunnel and are sent in the clear.

Both the VPN adapter and physical interface IP identities are visible to the host operating system's network stack, as evidenced by their use in the client's IP route table. Further, there is only one ARP cache maintained for the physical interface and it always maps only IP addresses on the local area network to hardware addresses. This makes the ARP cache susceptible to poisoning on a public access network since cache updates are not authenticated by the VPN.

Conventional, proprietary solutions secure devices in the Enterprise but not outside the Enterprise. Consequently, users have to rely on a potpourri of tools, including personal firewalls, virus scanners, virus signature updating, OS patch updates, layer-3 VPNs, and so on for protection while on the road. These tools impose an additional management burden, and worse, fail to adequately protect devices where public Ethernet is available. As discussed above, conventional VPN solutions have their shortcomings.

Much of the terminology and concepts that constitute the Internet and virtual personal networks are set forth in documents referred to as RFCs (Requests for Comments), promulgated by the IEEE (Institution of Electrical and Electronic Engineers). The RFCs are standards, drafts of standards, or proposed standards for the Internet and virtual personal networks. RFC's referred to throughout this specification, though not material to the present invention, are nonetheless relevant in that these documents represent the level of understanding of one of ordinary skill in the Internet arts, and therefore are incorporated herein by reference in their entirety for all purposes. It is understood, of course, that RFC's which postdate the priority date of the present invention do not constitute prior teachings with respect to the present invention.

### BRIEF SUMMARY OF THE INVENTION

Disclosed is a method of access control and privacy for mobile computers that can be used anywhere there is a wired or wireless public Ethernet provider.

A host simultaneously has two IP identities, local and remote, yet only the remote IP identity is visible to the host operating system's network stack. In an implementation of an illustrative embodiment the present invention, each IP identity has its own ARP cache and Address Resolution Protocol (ARP). The caches differ in their content and management. The local ARP cache is managed with respect to a connection of the host to a local subnet, and the remote ARP cache is managed with respect to a remote subnet reachable through a gateway on the local subnet.

The physical network interface of a host simultaneously has local and remote IP identities, yet only the remote IP identity is visible to the host operating system's network stack. The local IP identity is determined by a connection of the host to a local subnet. A gateway exists on the local subnet through which the host can access a remote subnet. The remote subnet determines the remote IP identity of the host for the lifetime of the connection to the local subnet.

The ARP cache associated with the local IP identity, called the local ARP cache, is hidden from the host operating system's network stack. Only the ARP cache associated with the remote IP identity, called the remote ARP cache, is visible to the host's network stack.

The host stores a hardware address for the gateway in the local ARP cache which is also called the local translation table. The local ARP cache maps the gateway's IP address to the gateway's hardware address. The mapping is obtained and validated through a secure method and is not altered by “Packet Reception” processing per RFC 826.

An ARP request received by the host for the hardware address corresponding to the host's local IP identity is resolved by local ARP. Local ARP returns the hardware address associated with the host's local IP identity.

The remote ARP cache, also called the remote translation table, only maps IP identities of hosts on the remote subnet to their associated hardware addresses.

An ARP request received by the host for the hardware address corresponding to the host's remote IP identity is resolved by remote ARP. Remote ARP returns the hardware address associated with the host's remote IP identity. Remote ARP complies with RFC 826 and may modify mappings in the remote ARP cache during the lifetime of the connection.

Hardware addresses associated with local and remote IP identities may be identical.

Remote and local ARP operate independently. Remote ARP does not update or inspect the local ARP cache, and local ARP does not update or inspect the remote ARP cache.

### BRIEF DESCRIPTION OF THE DRAWINGS

FIG. 1 illustrates an overall view of the present invention as embodied in RoadArmor

FIG. 2 illustrates a software stack (shim) according to the present invention.

FIG. 3 illustrates a conventional software stack.

FIG. 4 illustrates processing within the software stack of FIG. 2.

FIG. 5 shows an example of a UDP according to the present invention.

FIG. 6 is a table shows an example of packet transfer.

FIG. 7 shows a typical deployment configuration of a public network and a private network (e.g., VPN) within which the present invention can operate.

FIG. 8 shows traffic flow in the deployment configuration of FIG. 7.

FIG. 9 shows a sequence for creating a SafeConnect session.

### DETAILED DESCRIPTION OF THE INVENTION

In the descriptions to follow, specific details for the purposes of explanation are set forth in order to provide a thorough understanding of the invention. However, it will be apparent that the invention may be practiced without these specific details. For example, the embodiment described below makes reference to a “RoadArmor” which is the Assignee's internal designation of a software system embodying various aspects of the present invention disclosed herein. The disclosure also describes a commercial implementation of RoadArmor referred to as SafeConnect™. It is noted that different forms of the term RoadArmor, such as “Road” or “RA”, appear hereinbelow in describing embodiments of the various aspects of the present invention.

Though the embodiments of the present invention disclosed herein were made at the time of the invention, it will be readily apparent from the teachings herein that the present invention is readily embodied in all modern operating systems, and can be incorporated in various devices including but not limited to network devices such as routers, bridges, gateways, and to data processing systems (e.g., personal computers, workstations, laptop computers, and so on).

In addition, the client machines described herein execute as WirelessWall® clients or as conventional Windows® clients. WirelessWall® is a software product made and sold by the Assignee of the present invention for securing wireless local area networks (WLANs). It will be apparent that the present invention can be practiced without the WirelessWall® software client, and that a client machine can be adapted in accordance with the present invention absent the WirelessWall® software. Windows® is an OS produced by Microsoft Corporation.

I. Terms and Definitions

Terms and acronyms which may appear in the following discussion are defined below:
BHO—Browser Helper Object for Internet Explorer.
Broadcast bit—A bit of the flags indicating if the encapsulated frame is a broadcast or multicast frame.
Control bit—One bit of the flags indicating if the encapsulated frame is a control frame.
CE—Customer Edge.
Enterprise IP address—The Enterprise IP address of a station.
ISP—Internet Service Provider.
ISP-assigned IP address—The public or private IP address assigned to a station by an ISP.
ISP network—The subnet and physical network RoadArmor is connected to in order to transmit traffic.
Gateway IP address—the IP address of the local IP gateway on the ISP network.
ISP IP address—the IP address the client is given on the ISP network.
MTU—maximum transmission unit, the largest packet of data that a given communication layer can send
NAT—Network address translation.
NSP—Native Service Processing.
Protocol version—Four bits of the flags indicating protocol version.
PE—Provider Edge.
Physical Interface—the driver for the NIC connected to the ISP network.
PSN—Packet-switched network.
Public IP address—The public address of a station. It may be the IP address of a NAPT router or the IP address of the station itself if assigned a public IP address.
Public UDP port—The public UDP port of a station. It is the port assigned by a NAPT router if the public IP address of the station is the IP address of the router, or is the Tunnel port if the station is assigned a public IP address.
PW—Ethernet pseudo wire.
RoadTunnel—an Ethernet-in-UDP tunnel between the client and the concatenator. This is also referred to as “RA tunnel,” or “EtherUDP tunnel.”
RoadARP—the ISP facing ARP handling mechanisms of RoadArmor.
RoadIP—the ISP facing IP handling mechanisms of RoadArmor.
RoadArmor Concentrator—a machine which receives routed RoadArmor traffic from clients and decapsulates/decrypts it to the secured network. The termination point for a RoadArmor tunnel.
RoadArmor Client—RoadArmor BHO, RoadArmor RAS and RoadArmor tunnel driver.
Road Interface—the virtual or NDIS driver which provides the OS interface to the RoadTunnel connection.
RoadArmor Remote Access Service (RRAS)—The remote access service on Windows providing support for the RoadArmor tunnel driver.
RoadArmor tunnel driver—The intermediate driver for tunneling Ethernet over a LAN/WAN.
OS network—The virtual network which contains only secure, decrypted traffic, on either the client or concentrator side.
SLB—Server Load Balancer.
SPI—32-bit Security Parameter Index used to identify a security context, and hence a session.
Tunnel port—A static target port chosen during installation for RoadArmor tunnel termination. It has the same role as UDP port 4500 for IPSec ESP transversal of NAT.
SMB—Server Message Block.
   II. RoadArmor Overview Description

Today, proprietary solutions secure devices in the Enterprise but not outside the Enterprise. Consequently, users have to rely on a potpourri of tools, including personal firewalls, virus scanners, virus signature updating, OS patch updates, layer-3 VPNs, and so on for protection while on the road. These tools impose an additional management burden, and worse, fail to adequately protect devices where public Ethernet is available. Embodiments of the present invention provide a VPN having an appropriate model of access control and privacy for mobile computing devices to access the Enterprise which can be used anywhere there is a wired or wireless Ethernet provider.

WiFi HotSpot providers are an example of a public Ethernet provider as are providers of wired Ethernet in hotels and conference centers. Wired Ethernet providers have done nothing about security. Their view is that security is the end user's responsibility. Some HotSpot providers are taking a different view. Boingo and T-Mobile, have announced support for WPA (wifi protected access) and possibly for WPA2 based on IEEE Std 802.11i.

There are at least two reasons why these efforts are inadequate even though WPA provides link-layer protection:
1) The 802.11 WLAN architecture is unsuitable for public deployments no matter what type of link cryptography and integrity is used. Threats still exist under 802.11i because a BSS (basic service set) can be shared with an untrusted user in a HotSpot. Providers cannot overcome them and remain 802.11 compliant.
2) Enterprises, financial institutions, and DoD will not rely on HotSpot providers for privacy and integrity. They will rely instead on technologies they trust, control, and manage.
   It will be apparent from the description of the present invention that embodiments of the present invention, such RoadArmor for example, provide the desired level of security in a WiFi environment while maintaining compliance with 802.11.

RoadArmor (RA) is a virtual private Ethernet service. It provides Ethernet integrity so that the only mobile-device threats in public places are those that stationary desktop computers already face in the Enterprise. RoadArmor extends Enterprise-LAN security practices to all mobile devices that connect to the LAN from public places. It eliminates the need for technologies beyond what is present in the Enterprise to secure mobile devices in public places. Neither IPSec nor SSL VPNs can make this claim. Yet RoadArmor rivals SSL VPNs in ease of use.

IEEE Std 802.16 specifies tunneling ATM and Ethernet. Therefore, as a virtual private Ethernet, a RoadArmor tunnel is already among those protocols whose tunneling is conforms to 802.16, or WiMAX.

RoadArmor has two major components: 1) the client and 2) the concentrator. In an embodiment where the client is a Windows machine, the client can be further divided into an Internet Explorer BHO (in a Windows implementation, this is the browser helper object for the Internet Explorer), a Remote Access Service (RAS), and a tunnel driver. This particular embodiment of the present invention will be discussed in further detail below. The client can operate downstream from a NAPT router [RFC3715] and is installable on any client device running one of the following operating systems: Windows 2000, Windows XP, or Windows XP Tablet PC Edition. Other OS's can be supported such as used to run Pocket PCs. In general, most operating systems can be adapted according to the teachings of the present invention.

There are two areas that are relevant to RoadArmor. They are: UDP encapsulation of IPSec ESP for traditional NAT transversal; and Martini tunnels, or Ethernet pseudo wires [PWE3-arch]. The latter is concerned with point-to-point Ethernet service over a provider network. Virtual Private LAN Service (VPLS) is an alternative to the point-to-point Ethernet service when the provider network supports MPLS. VPLS is referred to as an MPLS layer-2 Ethernet multipoint service. The term VPN is used to describe the virtual private circuits constructed through a provider network using BGP and MPLS but there is no use of IPSec.

The service model used in RoadArmor is similar to the point-to-point Ethernet service model, but nonetheless is novel over point-to-point Ethernet service. A RoadArmor tunnel is an Ethernet pseudo wire that operates in raw mode. Each tunnel endpoint is a PE. The client is also a CE. It describes an architecture consisting of Native Service Processing (NSP), Pseudo wire (PW) termination and the Packet-Switched Network (PSN) tunnel. These three components provide for a separation of concerns that allows certain aspects of tunneling to be changed without impacting the rest of the service. The PSN tunnel handles UDP encapsulation in RoadArmor. The PW termination handles Ethernet decapsulation, with the SPI serving as the PW demultiplexor. The NSP detects and handles Ethernet frame errors.

III. Simplifying Assumptions

In another disclosed embodiment of the present invention that is based on the Linux operating system, some simplifying assumptions are made. The current Linux client does not implement WirelessWall® (WW) frame fragmentation, merely reducing the driver's MTU for the WW overhead. This simplification has been maintained for the Linux RA client.

Another simplifying assumption, is that the disclosed embodiments of the present invention does not support a change in the RA client's NAT port during a session. The NAT port can change during a session if a new ISP IP address is assigned to the client or a NAT timer expires. Each event shall require the RA client to re-authenticate and establish a new RA tunnel. The latter event is expected to be infrequent to nonexistent with keep-alive packets.

For the disclosed embodiments NAT keep-alive packets must be ignored by the RA concentrator. A keep-alive packet should be generated by the client if no other packet to the peer has been sent in M seconds. M is a locally-configurable parameter with a default value of 20 seconds [RFC 3948].

IV. Overall Design

The foundations of the RoadArmor design is an Ethernet-in-UDP tunnel from client endpoints back to the RA concentrator. Though the RA concentrator is part of the RoadArmor embodiment; however, it will be apparent that the present invention does not require the RA concentrator. Each of these endpoints has an ISP IP address, and they are connected by a routable IP network which maps a local UDP destination port (default 8097) to a publicly routable IP address and UDP port.

The Ethernet-in-UDP tunnel is visible to the OS's networking stack as an ethernet driver. All frames sent to that driver are encapsulated, routed to the other endpoint, decapsulated, and appear on the other endpoint as ethernet frames. Thus, as far as the OS's networking stack is concerned, the two machines are directly connected over ethernet. Each client is configured to create a RoadArmor tunnel back to the publicly-addressable RA Concentrator. The RA tunnel driver, in turn, must keep track of multiple clients by MAC address, and encapsulate traffic destined for each client appropriately.

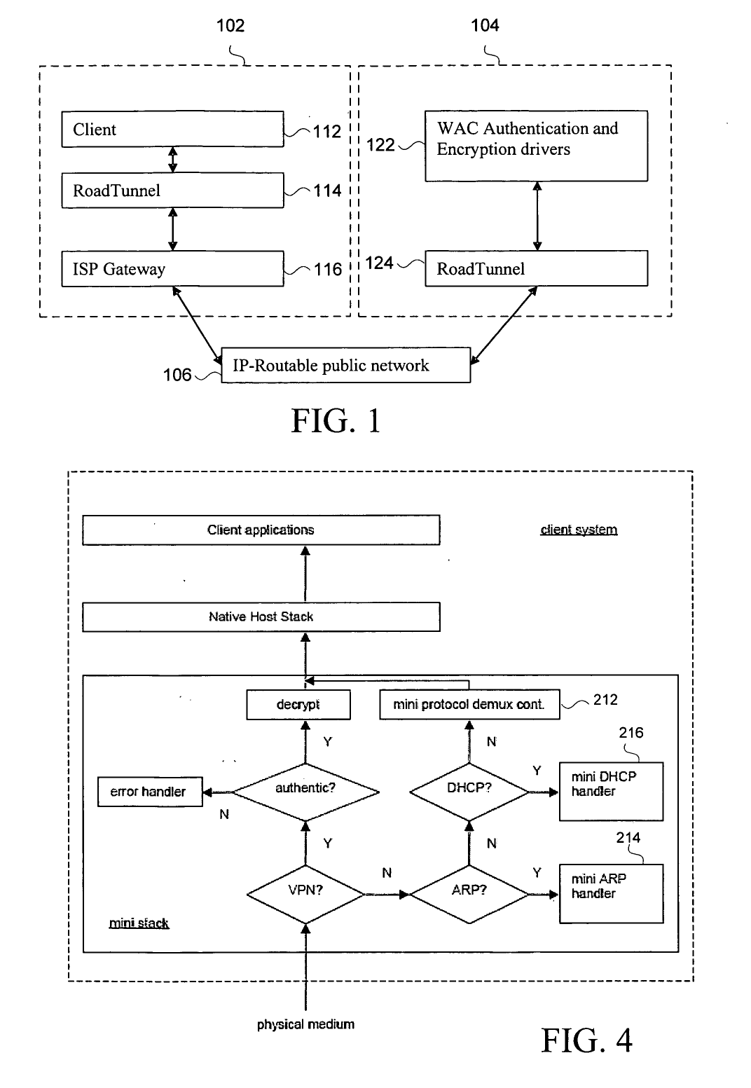

FIG. 1 illustrates various functional components of a client system 102 (e.g., laptop computer) according to the present invention. The client system 102 includes various client applications 102 that execute on the client system. RoadArmor proper runs the WirelessWall (WW) Linux (or Windows) client 122 “on top of” the client's end of this tunnel. The RA Concentrator 104 runs the normal WAC code, with the RA tunnel 124 attached as the untrusted interface. Thus, all the authentication and encryption tasks are handled by the existing WirelessWall code 122 and management tools. All traffic from the normal WW drivers gets passed to the underlying RA tunnel 114 for encapsulation. The WW clients thus have no direct access to the ISP Network, and no decision about whether their (encrypted) traffic should be encapsulated.

The RoadTunnel driver (114, 124) is the only part of either system (102, 104) which communicates with the outward-facing ISP network (106). The RoadTunnel driver handles all relevant networking protocols and communications without relying on any networking functionality provided by the OS. In this way, RoadTunnel traffic is not at risk if the OS is compromised in a manner which might modify the global networking state. In particular, the RoadTunnel driver is capable of:
1) Acquiring an ISP IP address from a DHCP server on the local subnet.
2) Communicating with the ISP gateway connected to a local NIC.
3) Establishing ARP connections with the Gateway so that it receives IP packets destined to its ISP IP address.
4) Receive IP packets from the gateway which are EtherUDP-encapsulated, decapsulate them, and send them to the OS networking stack.
5) Receive Ethernet frames from the OS networking stack, encapsulate them in EtherUDP, and send them out as routable IP packets to the Gateway's IP address.
6) Filtering all remaining incoming and outgoing traffic, blocking traffic between the OS's network and the ISP's network.

This is the minimum functionality to allow the WirelessWall client to communicate over the tunnel. In another embodiment, the EtherUDP tunnel includes additional features such as:
1) Expanding resilience to possible ARP attacks, including reply-forging and dynamic gateway changes.
2) Allow the EtherUDP tunnel to be disabled (possibly automatically) when the client machine has a direct layer 2 connection to the concatenator/WAC.
3) Providing for more complicated client access to the ISP network via logins, iPass®, accounting, etc.

On Linux, the EtherUDP driver can be implemented as a virtual interface, and on Windows as an NDIS interface. Both operating systems allow for stacking multiple interfaces of this sort on top of each other. This is vital because the client for each OS (and the encryption module of the WAC in Linux) is implemented in the same way (virtual interface/NDIS driver).

On Linux, these drivers are “stacked” explicitly, with each driver specifying the lower-level (i.e., closer to the physical interface) driver to receive and transmit frames on. Thus, the WirelessWall driver specifies the RoadArmor interface as its underlying interface, and the RoadArmor interface uses the Physical interface as its underlying interface.

On windows, NDIS drivers are stacked as well, but the ordering and stacking is not explicit. Each NDIS driver is assigned a level. Drivers of different levels are guaranteed to be ordered in the stack by level. Drivers of the same level may be situated in any order by the OS. Currently, the Windows client runs at the lowest available NDIS level with a FilterClass setting of failover. In order to guarantee that it runs on top of the RA driver, the RA driver will have to be installed with a FilterClass setting of FAILOVER, and the WW client will be installed with a FilterClass setting of SCHEDULER which insures that it will be layered on top of the RA driver. This may create situations where other drivers may be inserted between the drivers in the stack, resulting in interference from these other drivers. A solution to this situation is beyond the scope of the present invention. However, an interim solution is to simply uninstall the offending drivers.

In an alternate embodiment of the present invention, the RoadARP and RoadIP handling are directly incorporated into the respective client interfaces, and the EtherIP driver currently used for roaming serves as the concatenator end. This embodiment may be advantageous in that it would remove some redundancy on the WAC/Concentrator end, and require less development work to provide a clean and complete virtual driver interface. However, in practice, the amount of additional development work to provide a full driver interface is smaller than the work required to modify the existing EtherIP tunnel on the concentrator side. The separate tunnel approach also allows for much cleaner unit testing and problem isolation, as the EtherUDP units can be tested separately from the WAC Authentication and Encryption drivers. This would significantly reduces the testing and debugging burden. In yet another embodiment, the RoadArmor functionality can replace or integrate the roaming features of conventional EtherIP drivers.

More generally, the present invention allows for much more code re-use, as well tested components like the RoadTunnel can be used independently in other areas, and in other implementations. The tunnel would not have to be replaced if the WirelessWall clients changed above it, for example. Such modularity can be expanded into other parts of both the product design and the codebase.

V. ISP Network Attachment

The most basic functionality of the RoadTunnel driver allows the client to appear as an ethernet connected IP node on the ISP IP network, while isolating the OS's network traffic from the ISP network. This provides the networking isolation and layer-2 transparency that is the foundation of RoadArmor. As noted above, RoadArmor is responsible for providing all ISP network functionality, without involving the OS's networking stack. This includes:
1) Ethernet protocol handling—The RoadTunnel driver provides a simple ethernet protocol handler to distinguish ARP, DHCP and IP traffic.
2) DHCP handling—A DHCIP address is acquired by the RoadTunnel driver when the RoadTunnel driver comes up, and is renewed when its lease expires. This is referred to below as a mini DHCP protocol handler.
3) ARP handling—The RoadTunnel driver responds to ARP requests for its ISP IP address, and acquires the MAC address of its gateway so that it can transmit IP traffic. This is referred to below as a mini ARP protocol handler.
4) IP protocol handling—The RoadTunnel driver handles and forms IP packets to and from the ISP network's IP addresses and the other endpoint's public IP address.
5) UDP protocol handling—The RoadTunnel driver adds and removes UDP headers, adding source and destination port numbers for all transactions, and keeping track of the port used in a natural address translation (NAT) of the other end of the tunnel.
6) Ethernet-in-UDP encapsulation—EtherUDP encapsulation consists of raw ethernet frames as the UDP payload. The RoadTunnel driver receive frames for encapsulations from the OS network, and pass decapsulated frames to the OS network.
   The IP protocol handling, the UDP protocol handling, and the Ethernet-in-UDP encapsulation are collectively referred to below as the mini IP protocol handler.

A. Ethernet Protocol Handling

At the most basic level, the RoadArmor tunnel driver according to the present invention is capable of receiving full ethernet frames from the physical interface, distinguishing them by MAC address and ethernet protocol, and handing the payload to handlers for those protocols (ARP, DHCP, and IP).

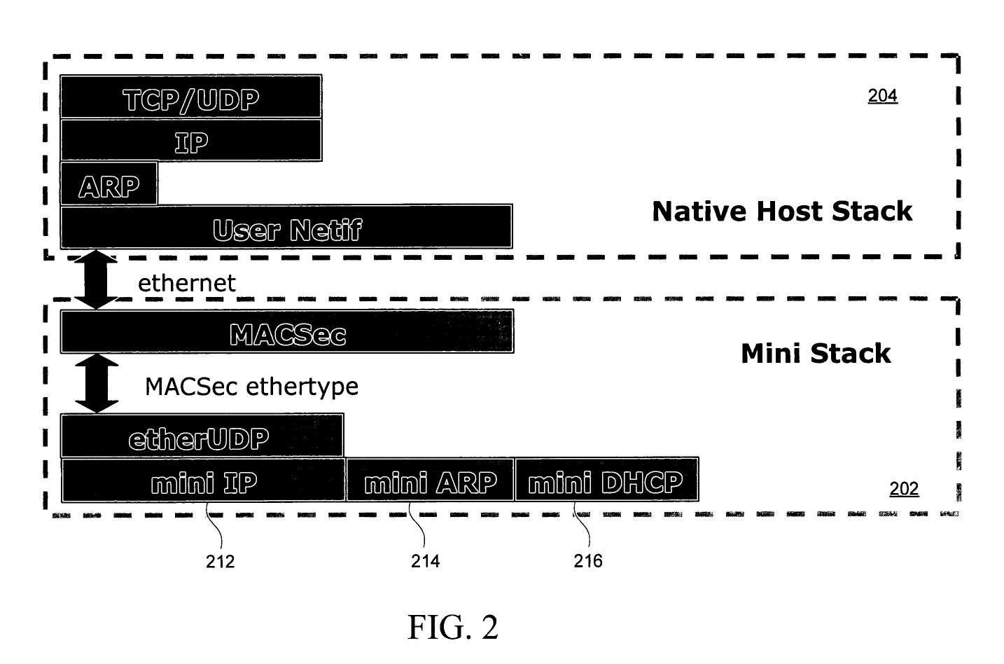

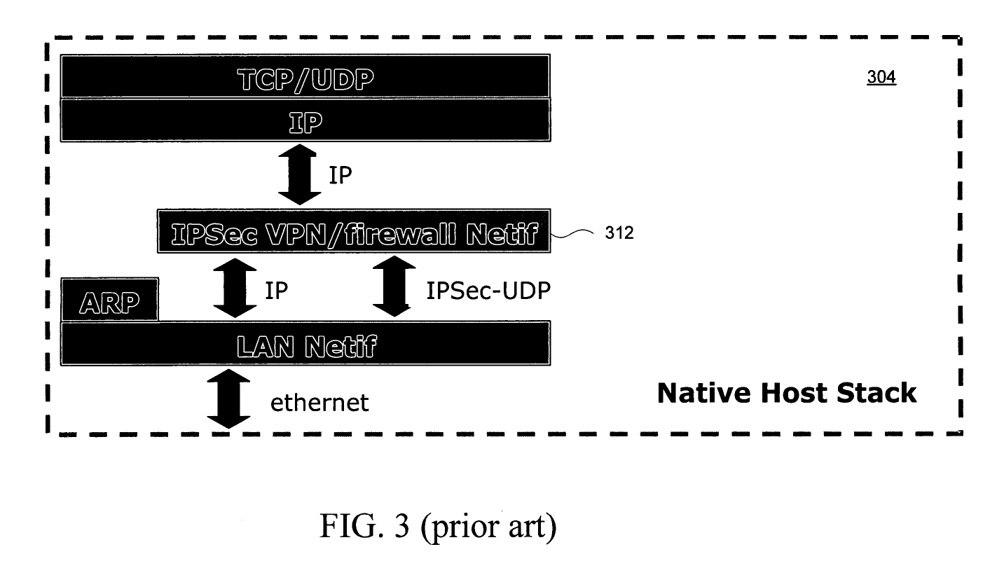

FIG. 2, discussed in further detail below, shows the RoadArmor tunnel driver of the present invention embodied as a “mini: stack 202, a shim that is inserted below the OS's native host stack 204. The mini stack 202 includes a mini protocol demux 212, a mini ARP handler 214, and a mini DHCP handler 216. When a non-VPN packet is received, it is determined whether it is ARP, or DHCP, or some other protocol (e.g., IP). The figure explicitly shows decision boxes 216, 214 for ARP and DHCP, respectively. The mini protocol demux 212 represents similarly processing for other protocols. By comparison, with reference to FIG. 3, a conventional VPN driver (shim) 312 is inserted as a driver within the OS' native host stack 304. Processing performed by the RoadArmor tunnel driver is generally illustrated in the flow diagram of FIG. 4.

B. Design

RoadArmor is embodied as a device driver module that is installed or otherwise incorporated in an OS. In the disclosed illustrative embodiment, RoadArmor is implemented as a Linux virtual interface driver used to handle all of the RoadArmor networking traffic to and from the ISP gateway. This driver is capable of sending and receiving networking traffic to/from the underlying NIC. The driver provides a virtual interface, (e.g., road0 on Linux) to the OS network, and is connected to the physical device driver underneath.

On Windows, NDIS intermediate drivers are installed above the miniport driver (RoadArmor), and can filter all inbound/outbound traffic from the underlying miniport driver. In addition, the NDIS intermediate driver is capable of rejecting any received packets that fails a filter criteria as well as generating its own packets to send through the underlying miniport driver.

On Linux, the road0 interface will install packet handlers for the physical interface to accept all incoming frames. This packet handler will have a simple hard-wired ethernet protocol table to hand frames off to other RoadArmor handlers.

While the tunnel is enabled, RoadTunnel does not pass non-encapsulated traffic to the OS Network. On Linux, this is accomplished by configuring the driver not to participate in Linux ARP exchanges, and by setting up a simple iptables filter to drop all (IP) traffic arriving over the physical interface. No such filter is applied to the road0 interface, so only traffic which has passed through the proper handling will interact with the OS network. On Windows, unhandled packets can simply be dropped by the NDIS driver.

C. DHCP Handling (Mini DHCP Protocol Handler)

On initialization, the RoadTunnel driver acquires an ISP IP address. This may be acquired by DHCP, possibly passed down by a helper application, or statically configured if DHCP is not supported.

On Windows, the DHCP service automatically acquires an address when the underlying interface is brought up. The RA tunnel will use a user-level application to query Windows to find the IP address acquired, and send that address down to the driver via an IOCTL which is then stored for future use. It is important that the address be cached here, because Windows will release and renew DHCP (to OS Networking addresses) using encrypted frames once the client has authenticated. The RoadTunnel driver also handles DHCP lease expiration and sends out its own DHCP requests to update its IP address.

D. ARP Handling (Mini ARP Protocol Handler)

ISP network presence is established by monitoring the underlying physical interface, and responding and placing ARP (Address Resolution Protocol) queries to identify the tunnel with the ISP IP address, and the ethernet MAC address for the ISP gateway. This ARP handling functionality is referred to here as RoadARP.

1. Design

If the RoadTunnel driver has not received MAC information about the ISP Gateway (possibly via initial DHCP) when the first packet is transmitted for encapsulation, it sends an ARP request to the ISP gateway as part of the IP transmit process (discussed below). This function will maintain a single-entry ARP cache consisting of the MAC address of the Gateway. If that cache is empty, the RoadTunnel driver will place the frame to be transmitted on a pending queue. Then, an ARP request for the ISP Gateway IP address will be generated and sent over the underlying interface.

ARP frames will be received by a handler in the RoadArmor ethernet protocol table (protocol 0x0806). That handler will parse ARP requests to identify the IP requested, check it against the ISP IP address, and construct the response with appropriate MAC address. The handler will also parse ARP responses for the ISP gateway's IP address. If the MAC address for the Gateway is not in the ARP cache, the cache will be updated with the MAC address from the ARP reply. Then, all pending frames queued for transmission will be dequeued in order, and sent through the IP transmit process, as described below.

RoadARP never updates its ARP cache due to an ARP request received against the client's IP address, nor due to an ARP request whose source protocol address is the gateway IP address. Such updates, far example, can occur through Linux ARP when ARP requests arrive through EtherUDP encapsulated 0x0d0d frames from the concentrator. The only vulnerability then that remains is a forged gateway ARP reply to a RoadARP request.

2. Testing

RoadARP will primarily be tested as a pre-requisite of normal RoadTunnel functionality. Explicit tests should see it responding to all ARP requests for the ISP IP address (and no other IP address) on the ISP network with the proper MAC address (that of the physical interface). RoadTunnel traffic should cause one or more ARP requests to be sent out for the Gateway IP address, with the MAC address from the first reply being used for all future IP traffic.

E. IP and UDP Protocol Handling (Mini IP Protocol Handler)

Once ARP has established a basic IP presence, the ISP gateway will begin sending IP traffic to the physical interface. That traffic will be picked up by the road0 packet handler, and passed to the other (ARP being the first) ethernet protocol handler in RoadTunnel, RoadIP.

Currently, only one type of IP traffic is passed through the Road interface: Ethernet-in-UDP. EtherUDP encapsulation is trivial. Thus, the design and implementation of these two conceptually distinct pieces (IP handling and EtherUDP encapsulation) are currently heavily coupled. As need for additional IP handling on the ISP network arises, these two design pieces can be separate functional entities.

1. Receive Path

IP packets arriving over the physical interface are handled as follows:
1) Verify the destination IP address is the ISP IP address of the RoadTunnel.
2) Verify the integrity of the IP packet, including possible fragmentation
3) Check that the IP protocol is UDP.
4) Verify the UDP header's destination port number.
5) The concentrator will maintain the client's IP Address and UDP port number by MAC address.
6) Perform the normal handling of an ethernet frame on the EtherUDP payload, passing it to the OS network through the road0 interface.
7) Drop all packets with other protocols.

2. Transmit Path

All traffic being passed from the OS network EtherUDP encapsulated and sent to the ISP gateway for routing:
1) Allow configuration of the IP address of the other end of the RoadTunnel as a module parameter.
2) Receive frames to be transmitted for the road0 interface.
3) Verify that the RoadARP cache contains a MAC address for the ISP gateway. If not, send an ARP request and pend.
4) Create a new frame for transmission over the physical interface.
5) Fill in the ethernet header of the new frame with: the physical interface's MAC as sender, the ISP gateway MAC as receiver, and the IP protocol.
6) Construct an IP header as the first part of the new ethernet payload, with the other RoadTunnel node's IP address as the destination, the ISP IP address as source, and the EtherUDP protocol.
7) Fill in the remaining IP fields accordingly, and calculate the header checksum.
8) Construct a UDP header (8 bytes), with Source and Destination port 8097, and no checksumming.
9) Copy the received for transmission ethernet frame into the UDP payload after the EtherUDP header.
10) Transmit the frame over the physical interface.
   It is noted that the reported MTU of the road0 interface needs to be reduced to allow for the addition of the 42 bytes (14 Ethernet+20IP+8UDP) of header information that the EtherUDP adds.

Each of these steps is well understood, usually covered by an appropriate standard. Only two steps require new protocol work, namely, Concentrator client tracking and ARP requests. The design for frames pending ARP requests is discussed above.

Each client RA tunnel connects only to a single concentrator, at a well-known public IP address and port. The concentrator maintains connections with multiple clients, however. These connections are maintained based on the MAC address of the encapsulated (i.e., inner) ethernet frame. The concentrator stores the IP address and UDP port number into a suitable data structure (e.g., a linked list) for each frame that decapsulates with a new source MAC address. The concentrator then uses that IP and UDP port for future transmit frames with that MAC as a destination address. The WW client protocol does not use broadcast frames, and does its own internal multicast to multiple unicast handling, so explicit multicast support is not required in this particular embodiment of the present invention, but can be easily provided if needed.

VI. RoadTunnel/WirelessWall Integration

Though not required for the present invention, this section is provided for completeness. The integration of each end of a RoadTunnel with WirelessWall includes the following:
1) Configure and install a WAC and Linux/Windows client on separate machines.
2) Configure the WirelessWall client interface to use the road0 interface on the client machine.
3) Configure the WAC to use road0 as the Untrusted interface.
4) Wire each physical interface to the appropriate routable subnet.

When the Wireless Wall client attempts a login, control (EAP/TTLS) frames will be transmitted through the RoadTunnel interface and handled by the WAC. The WAC's responses will, similarly, be sent back to the client over the RoadTunnel.

In practice, the WW client and WAC virtual interfaces will need some modification to cleanly handle using a virtual interface for communication. Mostly, this should be a matter of cleanup for some of the packet handlers, and additional robustness for the MTU handling and frame fragmentation.

VII. Configuration and Packaging

There are a number of configurable elements, some required, some optional, to establish the RoadArmor tunnel, in addition to the normal configurations required of WirelessWall (certificates, for example). Specifically:
1) Each client must be configured with the IP address (and optionally UDP port) of the concentrator it will connect to.
2) Clients may optionally be configured with a static IP address and gateway until DHCP is fully supported.
3) Clients must be configured with the underlying physical interface to attach to.

On Linux, this is the only place that the interface is specified. On Windows, it is important to insure that RoadArmor is using the same interface as the WirelessWall client. If this address/port is misconfigured, the misconfiguration will not be readily apparent to the client. The user will simply get a message to the effect that contact with the Access Controller could not be made. This behavior is not unlike similar behavior seen with SSIDs.

VIII. RoadTunnel and NAT

IP Masquerading is the most common type of public hotspot Network Address Translation (NAT). IP Masquerading maps multiple private IP addresses to the same public IP address. Except for UDP and TCP, each IP protocol can only have a single active connection (with “active connection” usually defined by a timeout) to the public IP address. This would have precluded us from having multiple clients behind the same NAT router. UDP and TCP, however, can connect multiple private IP addresses on the same protocol using port mapping. Here, the NAT router maintains a forwarding table of {Public IP, Public Port} to {Private IP, Private Port}. Entries in the table can be fixed (static port forwarding, often used to direct traffic to specific servers [http, ftp, etc]). But most of them are dynamically added as private addresses make connections to external public ports. When a private address sends UDP (or TCP) traffic to a public IP address, the NAT router allocates it a public UDP port, and replaces the UDP source port with that public UDP port (usually, the router will attempt to allocate the same port number if possible) and the IP address with the NAT's public IP. Then, replies to that connection are returned to the public port and IP address. NAT then checks its table, replaces the public IP and port with the stored private IP and port, and routes the packet into the internal private network.

In short, IP masquerading NATs are designed to multiplex UDP and IP ports. By encapsulating our ethernet frames in UDP, in accordance with the present invention, we can use the full power of NAT to our advantage, without requiring explicit handling.

The primary issue remaining with NAT in this case is entries in the NAT table timing out. These timeouts are typically one minute. If no traffic passes between the client and concentrator for one minute, the NAT table will clear. Then, traffic from the concentrator to the client will not get passed along because there's not mapping for that public UDP port. Traffic will get dropped until the client sends a packet, but that may cause a new public port to be generated by the NAT router. The simplest solution is to send a regular stream of empty UDP keep-alive messages between the two ports.

IX. Split Tunneling (“Selective Bypass Tunneling”)

Split tunneling is more accurately referred to as “selective bypass tunneling”, since the functionality described is actually to allow certain traffic to bypass going through a secure tunnel, to be handled locally. VPN bypass aims to meet three requirements:
1) efficiency—not all traffic from a client should have to traverse the VPN tunnel,
2) communication with the local ISP (e.g., DHCP and PPPOE), and
3) provide access to local servers (e.g., a print server).

A conventional third-party VPN vendor meets there requirements through VPN bypass which is achieved by hacking routes in the host's native IP route table. Routes specify which packets bypass the VPN. Third-party VPN vendors introduce a VPN adapter (e.g., FIG. 3) with an IP-addressable interface that is visible to the host operating system's network stack. Proper use of the VPN adapter requires configuration of the host's route table in terms of this IP-addressable interface. The table and its management are completely outside the scope of a third-party VPN. Consequently, this approach is vulnerable because:
1) the VPN client relies on native OS route operations to configure the client's route table. These operations can have different effects on the route table depending on the OS. For instance, the Cisco VPN client (version 4.6.01.0019) has been shown to configure a Win2K route table in a way that makes the Win2K client more vulnerable than a WinXP client running the same Cisco VPN client. On a Win2K client, every route is assigned a route metric of 1, so traffic that a user thinks is going through the VPN is actually being sent on the local network; and
2) a Trojan can alter routes and bypass the VPN.

A. How RoadArmor Meets the Three Requirements

RoadArmor meet the first requirement by running all network applications that send or receive packets outside the RoadArmor tunnel on a virtual machine or interpreter that serves as a sandbox within which applications run. All memory references are checked for bounds errors and system calls execute fault-tolerant emulation code. For instance, disk I/O may be implemented as a RAM file system so that when the virtual machine terminates, there is no trace on the client of it or any execution of an application run on it.

Enterprise security policy determines which network applications and services can run on the virtual machine.

RoadArmor meets the second requirement through “mini” protocol handlers implemented in the RoadTunnel driver as a MAC service located just above the MAC layer. Handlers are implemented for all protocols necessary to connect, and to maintain that connection, to an ISP's local area network. Among the protocols for which RoadArmor introduces handlers are IP, ARP, DHCP and IEEE 802.1x.

As discussed above, FIG. 2 shows an illustrative embodiment of the RoadArmor tunnel driver of the present invention. FIG. 3 shows a conventional VPN-enabled stack structure 304 implemented entirely in the host OS, for purposes of comparison. Referring to FIG. 3 for a moment, a VPN driver 312 is installed in the host OS stack 304 to provide VPN capability. All ethernet packets received via the computer's network interface card (not shown) pass through the VPN driver 302.

The stack configuration according to the present invention of FIG. 2, however, includes a stack that is separate and distinct from the host OS stack. Thus, there is the notion of the “native” host OS stack 204 and a “mini” stack 202. The mini stack 202 includes a mini IP protocol handler (understood to be contained in the mini protocol demux 212), a mini ARP protocol handler 214, and a mini DHCP protocol handler 216.

With the mini stack 202, RoadArmor controls all IP routing of packets, and maintains its own route table apart from the host operating system's route table. An important consequence is that any attempt to modify RoadArmor's route table can be authenticated by RoadArmor. Only an authorized RoadArmor administrator can change routes. Trojans cannot.

IP routing and ARP are essentially split by RoadArmor. There is IP routing and ARP processing in the host OS (i.e., the native OS stack 204), and IP routing and ARP processing within the RoadArmor driver (i.e., the mini stack 202). However, they behave differently. IP and ARP handling in the native host stack 204 are completely insulated from activity on the LAN because the LAN is hidden from the host stack. The host stack 204 sees only a single net interface, namely that of the Enterprise network. The mini handlers 212-26 for IP and ARP in RoadArmor interface with the LAN. For instance, forwarding a packet to the ISP's gateway is the responsibility of the RoadArmor IP and ARP handlers (the mini stack 202), whereas forwarding a packet to an Enterprise gateway is the responsibility of the host operating system's IP and ARP handlers (the native OS stack).

Updates to the RoadArmor route and ARP cache can affect how packets are routed from a client; for instance, whether they're routed to an authorized gateway or to some other unauthorized host on the LAN. To guard against the latter possibility, RoadArmor route and ARP cache updates must be allowed only when they can be authenticated. Contrast this with an IPSec VPN where route and ARP cache updates are not authenticated and are controlled by the host OS. Routing in RoadArmor is determined by a security policy at the Enterprise. Thus, if a Trojan made an attempt to update the RoadArmor route table, say to bypass the RoadArmor tunnel, it would fail since the update could not be authenticated. However, route updates in the native host stack remain unauthenticated. A Trojan can still update these routes, however, the effect would be merely routing tunnel traffic to another host or gateway on the Enterprise LAN unless the RoadArmor tunnel is bypassed. So the Trojan threat in the remote case is no different than the threat within the Enterprise unless RoadArmor tunnel bypass is allowed by the Enterprise security policy. If a remote user is located on a SOHO LAN, access to which is controlled to prevent untrusted parties from connecting, and RoadArmor tunnel bypass is limited in that packets from a client that bypass the RoadArmor tunnel are destined only for private IP addresses then we can strengthen the preceding statement by saying the Trojan threat in the remote case is the same as the Enterprise unless RoadArmor tunnel bypass is allowed on a LAN with untrusted parties (e.g., a public access LAN). The Enterprise security policy for tunnel bypass should be location based. Bypassing might be prohibited on a public access LAN but allowed on a SOHO LAN if the access control and private IP address restrictions hold.

RoadArmor meets the third requirement through smart split tunneling which includes, but is not limited to, the access control and private IP address restrictions mentioned above coupled with stateful firewalling. The firewalling and private IP address restrictions are enforced by the same RoadArmor driver that provides the mini protocol handlers for meeting the second requirement.

Following is a discussion of an instance of smart split tunneling. Consider access to a local print server. A client initiates a TCP handshake in the three most widely-used network print protocols. The driver does stateful firewalling if we exempt outgoing traffic from the RoadArmor tunnel based on printer port number (e.g., ports 515, 631, 9100). The driver remembers a source port to enable a handshake with a local print server. The driver also knows when to encrypt and tunnel an outbound printer packet to a remote print server rather than to route it locally. Because the RoadArmor driver is a MAC service, it sees the hardware address associated with a particular printer. Replies to server discovery that come over a RoadArmor tunnel identify the hardware addresses of remote servers while those that do not come over the tunnel identify hardware addresses of local servers. The driver disambiguates servers by their hardware addresses. Servers with the same IP address are given unique proxy IP addresses to higher-layer protocols and applications by the driver which maps each such IP address to its real (possibly conflicting) IP address and its hardware address. The driver transmits outbound packets to the real IP address by overwriting the proxy address and encapsulating the packet within a frame whose destination address is the hardware address associated with the real IP address. This hardware address may be the address of a router or of the server itself. Based on the hardware address, the driver knows whether the frame must be tunneled to a remote server or sent to the LAN untunneled. The proxy scheme also reduces the number of tunneled ARP requests because the driver must respond to such requests against all proxy IP addresses.

The RoadArmor driver has a signature that is verified before it is enabled. Disabling the driver requires authentication of the disabler.

B. Browser-Based Installer

A further aspect of RoadArmor is the use of a browser-based installer. According to the aspect of the present invention this is a browser extension (e.g., a Browser Helper Object in Microsoft's Internet Explorer) or a Java applet that allows for two high-level functions. The first function is to allow a push or pull of the RoadArmor installation package to ensure that the user is always up-to-date and for ease of remote client upgrade. The installer is loaded either from a pre-assigned destination or from a secure web site. The installer should be “signed” to make certain that it cannot be spoofed. Once the signed installer is validated and on the client machine, the installer will download the target components (the RoadArmor components) to the client. The installer verifies with the user that he/she wishes to install this component and then runs the installation.

The second function of the installer is to allow for a short-lease license of the installed components. If this functionality is used, a license watchdog will be installed that will manage the license lease. When a lease expires, the license watchdog will perform an un-install of the leased components.

C. Public Login

Still another aspect of the present invention is login capability. Public login assumes that the client can access and pass traffic over the ISPs local network without needing to pass any additional networking traffic for Authentication, Authorization, or Accounting. Many “internet cafes” or public networks require some form of web-based authentication and credit card payment for ISP service. This authentication is inherently insecure, and securing it is outside of RoadArmor's current scope.

An embodiment of the present invention can be provided to operate in an iPass® environment. iPass® subscribers can bypass ISP login in favor of mutual authentication controlled by iPass®. The present invention can rely on whatever protocol iPass® runs with the ISP to enable service. Then our mutual authentication protocol executes to establish the L2 tunnel after service is established which RoadArmor can detect independently of iPass® or any web browser. Using iPass® to “secure” the granting of service would be a reasonable way to offload this burden without touching the ISPs.

An alternative is to use the stateful capability of the RoadArmor driver to keep track of the state of a TLS/SSL handshake being performed by an application such as a web browser. The driver can require that the handshake be completed with respect to certificates installed on the client when its controlled port is currently disabled. This would require the user to verify the signature of any server certificate presented using local certificates from recognized and trusted certificate authorities. The driver will not enable the controlled port otherwise.

D. ARP Resilience

The most general ARP poisoning attack is one which modifies the target's ARP cache by sending out a request with the wrong MAC address in the sender field. The current RoadARP implementation is immune to such attacks, but more determined attacks can still poison its cache. Forged ARP replies are the most likely possibility, although these are considerably more likely to be noticed by the ISP and ISP gateway.

In general, though, ARP poisoning is always a possibility in a shared layer-2 medium. The long term solution is to tie the correct ARP response (MAC Gateway IP pair) to higher level (strong) authentication. Therefore, in an alternative embodiment of the present invention, RoadTunnel maintains a queue of ARP received replies. The queue contains “poisoned” replies and one (possibly more for dynamic gateways) real replies. RoadTunnel then adds an IOCTL to cycle the ARP cache to the next entry and drop the current entry.

The client software invokes this IOCTL on a failed authentication handshake. This would cause the ARP cache to cycle through all possible responses until the client is properly authenticated. From then on, that MAC will be used for all future communications (unless another unsuccessful authentication occurs). Obviously, this may slow down initial authentication, but only on a network where ARP poisoning is rampant. In such a hostile shared network, there isn't a good way to deal with denial of service attacks. So, an approach like this, where the limit case is a Denial of Service (from constant, overwhelming ARP poisoning) and security is always maintained, is ideal.

E. Dynamic RoadTunnel Disabling

The current design puts a RoadTunnel interface under the WirelessWall client in order to establish a secure RoadArmor connection through a public, IP routable network. The normal WirelessWall client allows a secure connection through a direct layer-2 connection (WiFi or ethernet). Ideally, separate clients should not be required when switching from a public IP network to a direct ethernet. The most direct way to accomplish this would be to remove the RoadTunnel interface when the client is configured for layer-2 connections.

Accordingly, in another embodiment of the present invention, RoadArmor provides automatic detection of local WACs using a pass-through mode for RoadTunnel. When enabled, this mode simply passes all traffic from the physical interface directly out of the tunnel with no encapsulation, ARP, or IP handling. This way, there is no need to modify the client driver to use a different interface for layer-2 communications to a local WAC. One simply changes the RoadTunnel mode to connect to a RoadArmor concentrator. As with the ARP case, an IOCTL is provided to switch the RoadTunnel into or out of transparent mode. The client would start RoadTunnel in transparent mode, and attempt to contact any directly-connected WAC. If that authentication fails, the client application makes the IOCTL call, enabling RoadTunnel, and re-attempts.

X. Establishing a RoadArmor Tunnel

Having described the various components of RoadArmor, the discussion will now turn to the steps for establishing a RoadArmor Tunnel. To facilitate the discussion, an embodiment of the present invention in the context of the Windows OS will be described. It will be apparent, from the teachings above, that any OS can be adapted accordingly to use the present invention. There are three major steps for a remote station to establish a RoadArmor tunnel in the Windows environment:

A. Internet Connection

Initial attachment of a remote station to a LAN requires the Windows DHCP client and Windows ARP to configure the network interface with an ISP-assigned IP address and to get the hardware address of the ISP gateway in the station's ARP cache. A request is made to the RRAS to update its ISP bindings for the station, specifically with the fields of the DHCP offer and the IP address requested from, and acknowledged by, the ISP DHCP server. This address is the ISP-assigned IP address. The routing table, ARP cache and network interface are now configured by Windows in the usual way. Next the user runs IE with the RoadArmor BHO in order to get a connection from the ISP securely. The BHO is in a state here where only SSL connections are allowed. While in this state, the BHO attempts to determine whether an Internet connection has been established by pinging a RoadArmor concentrator. The step completes when a connection is detected.

B. Enterprise Connection

This step begins with the RoadArmor BHO requesting the RRAS to initiate a TTLS handshake with a RoadArmor concentrator. If the handshake succeeds and Zone Integrity is enabled then RRAS awaits confirmation from Zone that Zone integrity has been satisfied (RRAS can use the same Zone API regardless of whether ZoneAlarm, ZoneAlarm Pro or Zone Integrity server is used). If satisfied, RRAS generates keying material and enables the RoadArmor tunnel driver with the keying material and one ARP binding, specifically, the ISP gateway IP address and its hardware address both of which are known from the internet connection step. This completes the enterprise connection step.

There must be at least two retries to complete a TTLS handshake. If one cannot be completed, the tunnel driver has no way to authenticate inbound frames. So the remote station is vulnerable. There must be options at installation time from which to choose the action taken after Enterprise connection failure. Among the options are do nothing beyond what is guaranteed by the BHO and ZoneAlarm firewall, or disable the interface.

C. Enterprise IP Address Assignment

All traffic initiated by the remote station is tunneled after the enterprise connection step, however, it may not be meaningful tunnel traffic yet because Windows will still use the ISP-assigned IP address as the source IP address in the payloads of outbound tunneled Ethernet frames. Therefore after the tunnel driver is enabled, the RRAS kicks the Windows DHCP client service to get an Enterprise IP address. This request will be tunneled. The service will get a NAK upon first request if it tries to obtain the ISP-assigned IP address again. But it should eventually succeed with an Enterprise address and re-configure the network interface and routing table according to the gateway in the Enterprise DHCP offer and the Enterprise IP address. This completes enterprise IP address assignment step.

Following this step, the station's ARP cache will be populated with the hardware addresses of Enterprise hosts only from now on. Windows will never have any need from this point forward to obtain the hardware address of the ISP gateway. The default route in the routing table is the Enterprise gateway. The tunnel driver will use its single ARP binding to form the IP and Ethernet headers of raw tunneled packets that are sent to the ISP NAPT router. Only the RRAS and tunnel driver know this binding, Windows does not.

XI. RoadArmor Client

The discussion will now focus on software components in a Windows client that embodies aspects of the present invention. These components include the RoadArmor Remote Access Service, the RoadTunnel driver, and the RoadArmor browser helper object.

A. RoadArmor Remote Access Service

The RoadArmor Remote Access Service (RRAS) is a Windows service with the following requirements:
1) It maintains ISP bindings, those fields of the DHCP offer and the IP address requested from, and acknowledged by, the ISP's DHCP server. This address is the ISP-assigned IP address. The RRAS API includes a request to update these ISP bindings and to record them for future use.
2) It can initiate a TTLS handshake with a concentrator on a specified port (tunnel port). The RRAS API includes a request to initiate the handshake with a given IP address. The IP address is either the virtual IP address of a concentrator cluster or the public IP address of an individual concentrator. The address might be stored in the registry.
3) It maintains the ARP mapping of the ISP gateway IP address to its hardware address.
4) It generates tunnel keying material per RFC 2716. The request to initiate a TTLS handshake includes enabling the tunnel driver with the keying material and the preceding ARP mapping.
5) It kicked the Windows DHCP client to get an Enterprise IP address after the tunnel driver is enabled.
6) It can be requested to generate an ARP reply in response to an ARP request against the ISP-assigned IP address, which Windows knows nothing about. The RRAS forms an ARP reply that is transmitted without tunneling. It can also be requested to transmit, without tunneling, an ARP request using the ISP gateway IP address as the ARP target protocol address and the ISP-assigned IP address for this station as the ARP source protocol address. Both types of request effectively proxy ARP for the ISP-assigned IP address. The former is demand driven and the latter is data driven. Either way, the ISP gateway learns the remote station's hardware address as a result.
7) RRAS terminated an Enterprise connection at user request, or after an idle period. This involves disabling the tunnel driver and placing the station in the state following Enterprise connection failure. RRAS should attempt to notify the RoadArmor concentrator of tunnel termination through a tunneled control frame before disabling the tunnel driver.
8) RRAS should support CAC authentication.
9) RRAS handled DHCP renewals of the ISP-assigned IP address, and generate an ICMP ECHO REPLY in response to an ICMP ECHO REQUEST against the ISP-assigned IP address.
10) RRAS supported a TLV packet format for the exchange of information between it and a concentrator over the TLS record layer following mutual authentication.

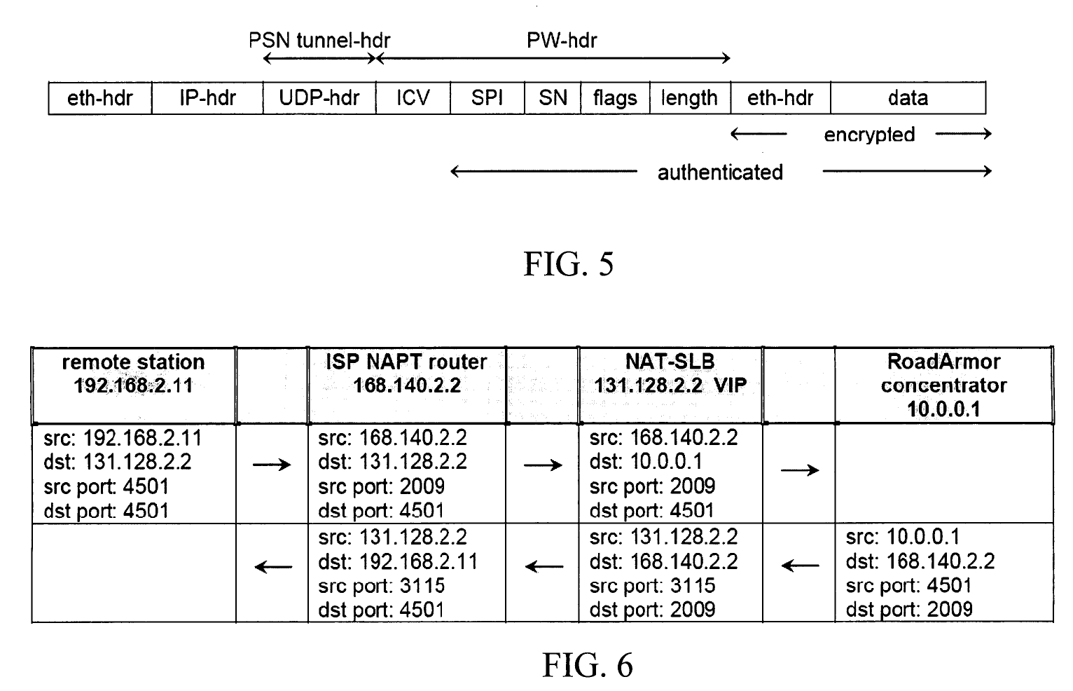

B. RoadArmor Tunnel Driver
1) The tunnel driver architecture mirrors that of a PE device in an Ethernet PW. The PE device is co-located with the CE device in the client. There is a statically-configured port for UDP encapsulations called the tunnel port. It is chosen upon installation. A default tunnel port is provided.
2) One bit of the 8-bit flags field is the control bit. If set, the frame is a control frame.
3) One bit of the flags field is the broadcast bit. If set, the frame is a broadcast or multicast frame.
4) One bit of the flags field is the encryption control bit. If set, the frame is encrypted.
5) The remaining flags field bits include protocol version and fragmentation bits.
6) The tunnel driver strips the UDP header from an inbound datagram destined for the tunnel port. It must demux the frame according to the control bit of the flags field. If not set, the driver decapsulates the RoadArmor-encapsulated Ethernet frame based on the SPI. If decapsulation succeeds (integrity checks and no replay) then the frame is handled by the Windows TCP/IP stack.
7) The tunnel driver drops NAT keepalive packets.
8) The tunnel driver intercepts and encapsulates, in UDP, every Ethernet frame from the Windows TCP/IP stack. The frame is encrypted. An Integrity Check Value (ICV) is calculated over the result, the SPI, the flags field, the sequence number (SN) and length. The ICV, SPI, flags field, sequence number, length and ciphertext form the data of a UDP datagram. The UDP header destination and source ports are the tunnel port and the UDP check sum is zero. The UDP encapsulation for NAPT [RFC3022] follows [IPSec-UDP]. The tunnel driver adds an IP header to route the datagram to the concentrator, and finally adds an Ethernet header for transmission to the ISP gateway. The resulting packet is shown in FIG. 5.
9) The MTU must be reduced by the size of an Ethernet header, an IP header, a UDP header and the RoadArmor header. There can be no IP fragmentation of the UDP datagram before NAT.
10) The tunnel driver does de-fragmentation of encapsulated Ethernet. It does not fragment Ethernet.
11) The table in FIG. 6 illustrates packet transfer from a remote station to a concentrator in a cluster via a NAT-SLB, and a trip from the concentrator to a remote station. Both the station and concentrator run behind NAT devices. The private IP address 192.168.2.11 is the ISP-assigned IP address for the station. The IP address of the NAPT router 168.140.2.2 is the remote station's public IP address. Source port 2009 is a dynamic port assigned by the NAPT router and port 4501 is the static tunnel port. Port 2009 is the public UDP port of the remote station. The tunnel driver on the station tunnels to the virtual IP address 131.128.2.2 of the NAT-SLB. The SLB's load balancing algorithm determines, perhaps through source-IP hashing, that concentrator 10.0.0.1 is the packet's destination. The concentrator tunnels to the station's public IP address and public UDP port. Port 3115 is a dynamic port assigned by the NAT-SLB.
12) RoadArmor runs under Microsoft Windows 2000 and Windows XP and later.
13) Minimum hardware configuration: Intel Pentium III laptop, or greater, with
   20 GB Hard Disk
   128 MB memory
   500 MHz Intel-based processor

1. Traffic Flow from Station to Concentrator

The source hardware address in the outer Ethernet header is that of the station while the destination hardware address is that of the ISP gateway. The ethertype is IP.

The destination IP address in the outer IP header is the public address of the concentrator. The source IP address in the outer IP header is the IP-assigned IP address.

The UDP destination and source ports are the tunnel port. The UDP checksum is zero (not computed).

The destination hardware address of the inner Ethernet header is that of the concentrator or an Enterprise host on the concentrator's subnet. The source hardware address is that of the remote station.

The source IP address in an ARP or IP packet that follows the inner Ethernet header is the Enterprise IP address of the remote station.

2. Traffic Flow from Concentrator to Station

The source hardware address in the outer Ethernet header is that of an Enterprise host on the concentrator's subnet. The destination hardware address is that of the concentrator's gateway. The ethertype is IP.

The destination IP address in the outer IP header is the public IP address of a remote station which may be a NAPT router. The source IP address in the outer IP header is the IP address of the Enterprise host.

The UDP destination port is the remote station's public UDP port (NAPT port or tunnel port). The source port is the tunnel port. The UDP checksum is zero (not computed).

The destination hardware address of the inner Ethernet header is that of the remote station. The source hardware address is that of the Enterprise host.

The source IP address in an ARP or IP packet that follows the inner Ethernet header is the IP address of the Enterprise host.

C. RoadArmor BHO

Following are functions for the browser helper object for Internet Explorer (IE) in accordance with an embodiment of the present invention.
1) Interface to RRAS in tunnel establishment.
2) Detects Internet connection in tunnel establishment.
3) Enabled upon browser launch according to enable/disable setting.
4) Disable the browser's ability to accept unrecognizable certificates. This allows SSL connections to only those sites whose certificates are signed by a trusted CA.
5) Block form data to web sites that are not protected by a SSL connection. This always protects user credentials with SSL. It also forces the first step of establishing a RoadArmor tunnel to always occur over a SSL connection.
6) Cache the hardware address of the gateway that is used to establish the SSL connection to the ISP in the first step of forming a RoadArmor tunnel. This should be the gateway in the ISP's DHCP offer.
7) Periodically refresh the Windows ARP cache with the gateway's IP address and hardware address.
8) Optional pop-ups suppression.
9) Optional blocking of JavaScript.
10) Limit out-of-band execution from untrusted sites. Some sites bury spyware in ActiveX controls on the site. RoadArmor can prevent these from downloading or executing.
11) Allow trusted sites full access. If a site is on the trusted list, the site is no longer validated for threats.
12) Bundle with spyware scrubber.
13) Prevent access to IE Restricted (blacklisted) sites. The feature cannot be disabled by nonadmin.
14) Allow access to IE Internet sites (those that are neither trusted nor restricted) but do not cache any content from them.
15) Allow access to IE Trusted sites and allow content from them to be cached.
16) Allow option to access IE Trusted sites via SSL only.
17) Do not allow the access-control policies for IE Restricted, Internet and Trusted sites to be changed.
18) Administrator can provide access to new access control lists by pull mechanism. This allows remote administration of white- and black-listed sites.
19) Browser option to flush cached content from IE Internet sites only.
20) Browser option that forces IE history to ignore IE Internet sites while option is enabled.
   XII. RoadArmor Concentrator

Details for a specific embodiment of the RoadArmor Concentrator will now be given. In accordance with the present invention, the concentrator responds to ARP requests against the Enterprise IP address of a remote station originating on the Enterprise LAN. In response to an ARP request against a remote station's Enterprise IP address, the concentrator responds with the hardware address of the remote station, not its own hardware address as with proxy ARP. This will reduce the amount of broadcast traffic sent through tunnels. Note that this is only an optimization since the Windows TCP/IP stack on the remote station would respond to tunneled ARP requests against the station's Enterprise IP address.

In accordance with the present invention, the concentrator, in response to a RARP request against a remote station's hardware address that originates on the Enterprise LAN, responds with the Enterprise IP address of the remote station.

The concentrator discovers the public IP address and public UDP port of every remote station. The public address may be that of an ISP NAPT router or of the station itself if assigned a public address by the ISP. In the former case, the port is an assigned port created by the NAPT router and in the latter case, it is the tunnel port. The address and port can be determined from the TTLS handshake in the second step of establishing the RoadArmor tunnel if the handshake succeeds. RFC 3022 states that a NAPT router may map a single tuple (private IP address, private port) to one or more tuples of the form (assigned IP address, assigned port) that vary on their assigned ports but not on the assigned IP address [RFC3022]. That means received tunnel traffic from a single station may vary on UDP source ports and these ports may not match the public UDP port. As long as the mapping to the public UDP port remains alive, it can continue to be used as the destination UDP port in the tunnel from the concentrator. Any of the UDP source ports of incoming datagrams in the tunnel, however, could serve as a public UDP port for the remote station as long as it is alive, since each of these ports will be mapped to the tunnel port by the NAPT router.

The concentrator transmits NAT keepalive packets, per [IPSec-UDP], against the public UDP port. Their interval is statically configurable and not to exceed the dynamic port mapping timeout. Keepalive packets are not encrypted but are UDP datagrams per the Internet Draft. NAT timeouts come in many flavors. Linux defines four flavors, the first three of which are configurable: timeout after TCP FIN (2 mins), TCP session timeout (15 mins), timeout after UDP (5 mins), and ICMP timeout (125 secs). Cisco routers define nine flavors, the most important of which is the UDP timeout (5 mins).

The concentrator fragments Ethernet according to the same MTU used by the client. It does not de-fragment Ethernet.

For each concentrator, there is a set of remote stations, distinguished by MAC address, for which the concentrator provides tunneling service. The set is determined by those stations that completed a TTLS handshake with the concentrator. The set can range from all remote stations from an Enterprise to just those for which a load balancer is providing source-IP persistence. Unicast frames received on the LAN interface destined for a remote station serviced by the concentrator must be tunneled to that station. If not serviced by the concentrator, then they are logged and discarded, which should occur infrequently on a switched LAN. A broadcast frame received on the LAN interface must be tunneled to all remote stations serviced by that concentrator. A broadcast frame received from another station serviced by the concentrator must be bridged to the LAN interface and tunneled to all other remote stations serviced by that concentrator. Likewise a multicast frame received on the LAN interface must be tunneled to all stations serviced by the concentrator that are also members of the multicast group.

XIII. HTTP/HTTPS Split Tunneling

The RoadArmor Tunnel driver tunnels every outbound frame. Therefore packets destined for a server outside the Enterprise must reach their destination via the Enterprise. This is the expected behavior because the driver is simulating an Enterprise LAN connection over a WAN. As a result, the Enterprise can impose the same policies on remote devices as local ones. For instance, one can force remote stations to use an Enterprise proxy web server. Email is also an important application that tunneling will benefit since Enterprise email servers reside in the Enterprise. However, tunneling may not always be desirable. For instance, browsing web servers outside the Enterprise will be done indirectly and thus will be slower. It therefore makes sense to consider split tunneling of http/https traffic in order to improve performance.

An option can be provided at installation time to specify whether http/https split tunneling is enabled. If enabled then the tunnel driver has to be modified in two ways:
1) Outbound http/https packets must be routed. Through the Enterprise DHCP offer, the tunnel driver knows the Enterprise netmask. It uses it to decide whether an outbound http/https packet should be tunneled to the Enterprise, or sent without tunnel encapsulation. This will preserve the station's ability to access web servers on an Enterprise intranet.
2) An inbound TCP segment may have to be admitted even though it has no ICV to verify its authenticity. A segment can now arrive from a web server outside the tunnel. The tunnel driver is faced with having to decide whether to admit it without a ICV to verify its authenticity. This departs from the ICV-based mechanism for controlling all access to a station. The driver must use a stateful firewall and admit only inbound segments received in response to http/https connections initiated by the station. The firewall will not protect against exploits, launched in public places, of any buffer-overflow and memory-management vulnerabilities that may exist in the browser code itself. However, the IE vulnerabilities exploited to date remain within the scope of what the RoadArmor1.0 BHO can prevent.

In accordance with the present invention, the RoadArmor concentrator is able to deny a station a session if that station is using split tunneling.

Split tunneling creates another problem. The minimum timeout when all traffic is tunneled is 5 minutes, the UDP NAT timeout. A NAT timer may be reset to 2 minutes after a browser transmits a TCP FIN packet. Consequently, there is a greater risk of a NAT timeout with split tunneling.

XIV. SafeConnect

To complete the disclosure of the present invention, a discussion of RoadArmor as implemented in Assignee's product called SafeConnect™ will be made. Features of the SafeConnect™ product beyond those disclosed above in connection with RoadArmor will be described.

A. Overview of SafeConnect

SafeConnect is the only secure solution for enterprise connectivity from hotspots, public networks, home wired and wireless networks. Using SafeConnect, authorized users can securely connect to their enterprise network from anywhere.

SafeConnect extends the hardened enterprise perimeter to include remote users—mobile, wireless and wired. Organizations can now leverage their existing firewalls, traffic filtering and other perimeter defenses to protect both off-site and on-site users. By using SafeConnect while away from the office, enterprise users now have the same secure access to internal LANs, applications and resources as if they were locally connected.

B. SafeConnect Components

SafeConnect includes the following software components:

1. Cranite Management System

The Cranite Management System (CMS) provides centralized configuration, monitoring, and management for Cranite security products. The Management System manages SafeConnect Access Controllers. Network administrators use the Management System to do the following tasks:
1) Specify and maintain the policies governing remote access to enterprise network. The Management System leverages information available in existing enterprise directories for authentication and policy selection based on credentials and group information stored in the directory.
2) Centrally configure and manage all SafeConnect Access Controllers and connected/associated remote users (nodes).
3) Monitor performance and usage of the secure network and make real-time changes to optimize the network or accommodate unexpected behavior.

2. SafeConnect Access Controller

The SafeConnect Access Controller software separates the untrusted public network from the enterprise's trusted internal network. The Access Controller forms the other end of the cryptographic tunnel with the SafeConnect Client. The Access Controller is the gatekeeper and performs all session management tasks required for secure LAN operation. These tasks include encryption and decryption, authorization, and firewall filtering.

3. SafeConnect Client

The SafeConnect Client software installs on end-user computers and forms one end of the cryptographic tunnel created with the SafeConnect Access Controller. The Client allows users to connect to their enterprise network from anywhere in the world that has Internet access. The SafeConnect Client also functions as a SafeConnect Client, providing secure access to an enterprise's wireless networks as discussed above in connection with the RoadArmor tunnel driver.

4. OpenLDAP and FreeRADIUS

The Cranite Management Systems ships with OpenLDAP and FreeRADIUS, which you can use as an alternative to other external directory and authentication servers, such as Active Directory.

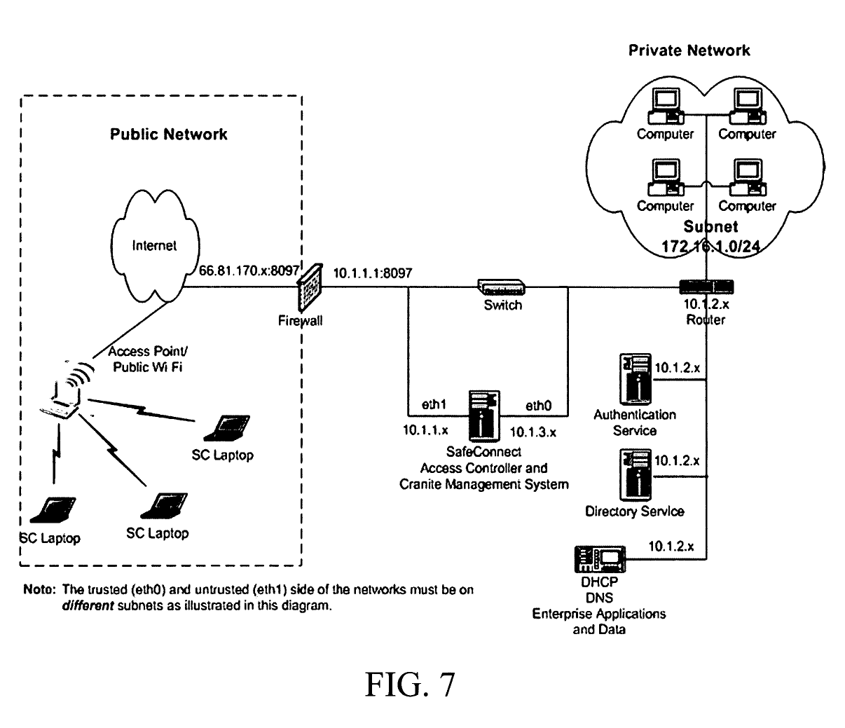

A typical SafeConnect deployment combines the Cranite Management System and the Access Controller on a single host as shown in FIG. 7.

C. How SafeConnect Works

This section provides a detailed overview of the technical operation of SafeConnect software. After establishing a virtual tunnel, SafeConnect manages the authentication process and Cranite-specific protocol extensions to prevent session hijacking or denial of service attacks. SafeConnect creates a unique 802.1x port on the Access Controller for each active connection.

1. Establishing SafeConnect Session

As shown in FIG. 7, the SafeConnect Client is installed on wired and wireless devices, which may be connecting through unknown, unsecure networks. All networking traffic from that device is encrypted by the SafeConnect Client, and then passed over the public network through the enterprise firewall to the SafeConnect Access Controller. The Access Controller verifies the Client's identity, integrity of data, and decrypts it. The decrypted data is then transmitted out through the Access Controller to the enterprise. This traffic is still subject to all internal network security. For example, external traffic passes through the enterprise firewall, but local server login is still required.

SafeConnect allows for additional applications not normally possible in a traditional VPN without any special configuration as the SafeConnect Client is on the LAN. For example, all are services that work by default on a LAN work by default through SafeConnect but they break without explicit allowance in the VPN gateway's security policy. That is, traditional VPNs security policy must be defined to handle protocols such as multicast, NETBIOS name, datagram, and session services. Without which services like NETBIOS-based peer discovery, name service browser election, and peer-to-peer SMB-based file sharing will not work.

The SafeConnect Client also receives its own DHCP assigned address, which may overlap with any privately assigned DHCIP addresses on the customer's remote network. This overlap can occur because the remote network is completely isolated from the network system to which the Windows system has access.

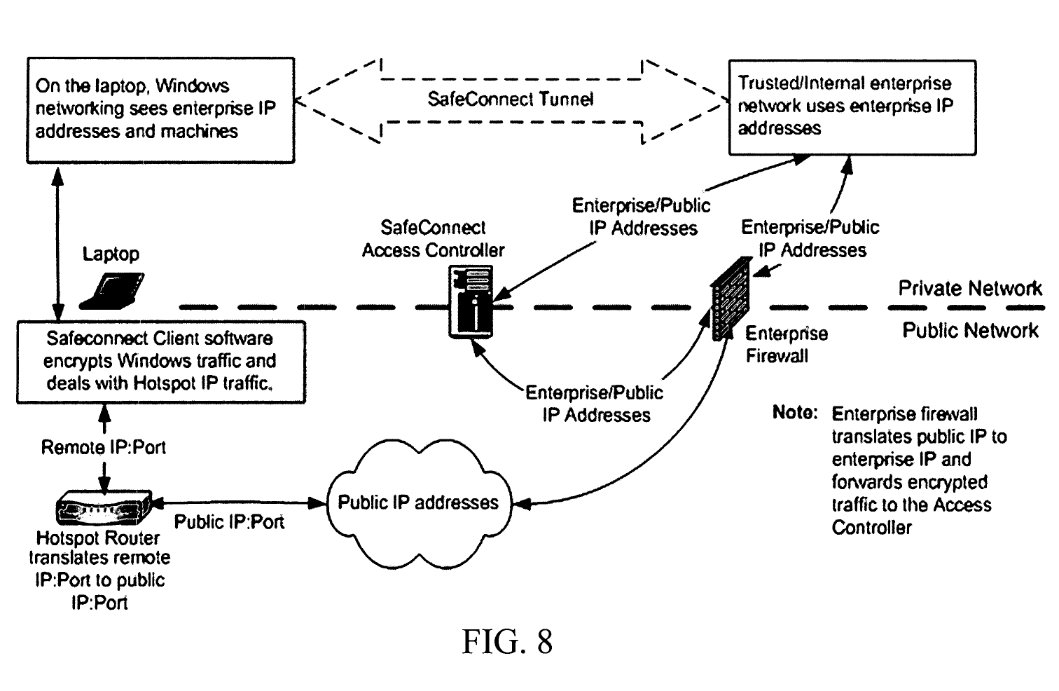

FIG. 8 illustrates a typical SafeConnect deployment. The network traffic above the dashed black line is all secure traffic over the enterprise network. Traffic below that line is all encrypted and protected by SafeConnect or by the enterprise firewall.

FIG. 8 shows the three different sets of IP addresses and the static port ID required to configure and deploy a SafeConnect system: ISP-assigned remote IP address, the Access Controller provided public IP address, and enterprise assigned IP address. Static port forwarding translates the Access Controller public IP address to the Access Controller's internal IP address. SafeConnect clients are uniquely identified by MAC address, eliminating IP address overlap problems common in environments using Network Address Translation (NAT).

Remote access VPN users who connect to a VPN gateway are normally assigned a private IP address by the gateway. This IP address may conflict with the IP address assigned to the user by the remote DHCP server (ISP/router). The SafeConnect Access Controller does not allocate IP addresses. An Enterprise DHCP server provides IP addresses for remote clients just as it does for local clients. In addition, the allocated addresses may overlap with private IP addresses assigned remotely to the user by an ISP without causing a problem.

As discussed above in connection with RoadArmor, SafeConnect is not vulnerable to ARP cache spoofing unlike a remote access VPN. A VPN tunnel can be terminated instantly and reliably with ARP cache poisoning using tools such as ala Ettercap. Whereas, a SafeConnect tunnel will not break in the face of ARP cache poisoning threats.

2. Creating a New SafeConnect Session

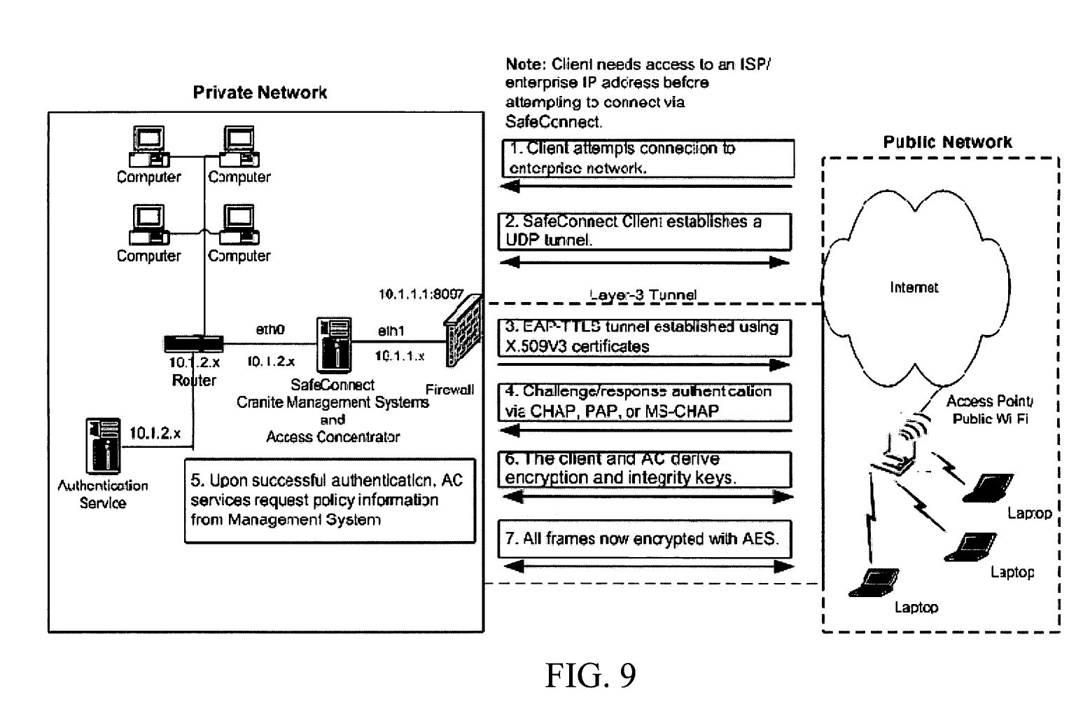

Before invoking the SafeConnect Client, the user machine must receive an IP address from the local ISP for operation on the local wired/wireless LAN. This is illustrated in FIG. 9 and discussed below.
1) When a user enters an area with wired/wireless LAN service to be secured by SafeConnect, the user first requests a secure session by selecting “SafeConnect On” on the SafeConnect Client user interface.
2) SafeConnect then establishes a UDP tunnel to the Enterprise network. The client's wireless/wired network interface is now dedicated to the tunnel and it will not accept any traffic unless it arrives through the tunnel. In addition, all traffic from the client machine also enters the tunnel.
3) The Client uses Extensible Authentication Protocol Tunneled Transport Layer Security (EAP-TTLS) next to authenticate with the Access Controller. The Access Controller presents its certificate to the Client during the TLS handshake. The Client uses this certificate with an X.509v3 enterprise certificate that is loaded on the Client during installation to verify the identity of the Access Controller, thus preventing any potential man-in-the-middle attacks. Upon the successful completion of the TLS handshake, SafeConnect establishes a secure tunnel between the Client and the Access Controller to carry all subsequent user authentication traffic over the TLS record layer.
4) The Access Controller then sends an EAP “Request-Identity” message to the Client. The Client prompts the user to enter a username and password. The Client sends the user credentials to the Access Controller through the secure tunnel. The Access Controller verifies the user's credentials with an enterprise RADIUS server.
5) After the user successfully authenticates, the Access Controller retrieves the group policy for the user, including the mobility support level and the per-user filter forth from the Management System. The Management System propagates the resulting session context of the user, such as the session lifetime, the mobility level as specified in the policy, home Access Controllers, and the TLS master secret, to other Access Controllers in the SafeConnect implementation through the secure TLS connection so as to facilitate seamless user roaming among Access Controllers.
6) Meanwhile, the Client and the Access Controller each independently derive the encryption and integrity keys—the same set of 128-bit session keys from the TLS master secret and the random numbers exchanged during the TLS handshake.
7) The data frames between the Client and the Access Controller are now protected by AES encryption and Message Integrity Code (MIC) checking.

3. Key Technologies

SafeConnect software uses trust relationships and a secure messaging structure to support authentication, message integrity, and privacy. The Access Controller and the Client present their X.509v3 certificates to one another to verify identity and derive a TLS session key. The Management System uses a RADIUS server to interface with the enterprise directory and manage the Client authentication process. The trust architecture is structured in the following way:
Each Access Controller uses an X.509v3 certificate to enable mutual authentication of the Access Controller and the Client during the TLS handshake. For the Client to verify the Access Controller's certificate, the Client trusts the Certificate Authority that issued the Access Controller's certificate. The TLS protocol ensures message integrity, provides protection against replay attacks, and ensures privacy.
Upon presentation of authentication credentials within the EAP-TTLS tunnel, the Access Controller communicates with the enterprise RADIUS server (using PAP, CHAP, or MS-CHAP) in order to authenticate the Client.
Upon successful Client authentication, the Access Controller retrieves the user's access policy from the Manager. The access policy also resides on all connected Access Controllers to ensure extremely low-latency secure roaming when a Client roams between subnets. All communication between the Access Controllers and the Manager uses TLS, which provides an additional layer of security.

4. Create the Trust Architecture

To create the trust architecture between the Cranite Management System, the Access Controllers, and each Client, the SafeConnect software installer installs a self-signed certificate on each component. This self-signed certificate is a universal certificate created for all Clients in the enterprise. These certificates are each signed by the issuing authority, either Cranite Systems, Inc., or the customer's own certificate authority. The use of a common, self-signed certificate frees the enterprise from the laborious and time-consuming effort of bringing up its own enterprise-wide certificate authority (CA). Rather than installing a unique certificate on every individual end-user station (PC, Mac, PDA), Cranite's use of a common enterprise certificate enables establishment of a high degree of trust between components while still requiring existing enterprise credentials (for example, username, password, biometrics, and smart cards) to authenticate.

5. Role-Based Policy Enforcement

One of the most powerful features of the SafeConnect software is its ability to enforce policies unique to each connection, including a policy allowing guest Internet access. This capability enables administrators to deliver differentiated services to remote users on the same network infrastructure. For example, the role-based firewall can limit traffic to a specific server while simultaneously allowing otherwise broad access to an authenticated remote user. This capability creates new opportunities for creative network design and infrastructure cost savings.

SafeConnect implements its role-based firewall with robust policy capabilities based on highly granular network traffic filtering. A simple web-based instrumentation dashboard allows security and network administrators to associate security policies with specific connections based on each user's existing group/domain associations as defined by the enterprise's directory service.

Policies have the following parameters:
Membership—Administrators apply policies based on the user's group membership within the enterprise directory. Doing so greatly simplifies ongoing management by ensuring that user moves, adds, and changes within the enterprise directory automatically propagate throughout wireless access policies.
Per-frame characteristics—SafeConnect provides significantly enhanced security versus other VPN solutions by enabling filtering of all traffic to and from the Client. This capability allows security and network administrators to segment and filter traffic based on user identification, network, protocol, and type of frame. SafeConnect can apply these filters unidirectionally, providing for the creation of extremely granular network access policies. SafeConnect enforces these policies at each Access Controller, even when a user roams to a different Access Controller.
Duration—Administrators configure session duration using the following methods:
Session-length timeout—Administrators typically set session length to be slightly longer than the typical duration of the user's workday. After this pre-defined period of time, SafeConnect prompts users to re-enter their credentials to continue as authorized users. Session-length timeout is part of all policies, as opposed to idle timeout, which some enterprises do not need. Session length timeout is set per policy and not per user.
Idle timeout—Environments that require the utmost security, such as healthcare, financial, and government, typically use idle timeout. Administrators configure very short idle timeout values to ensure that a user who leaves the device idle is not placing the device or networks resources at undue risk. The ability for the session to automatically time out after an administrator-defined period of time provides additional security and management without compromising the user experience.

6. Layer 2 Protection

SafeConnect software encrypts full Ethernet frames rather than just IP payloads, hiding vital information such as IP addresses, applications, and ports from unauthorized radio receivers. Frame-level encryption also protects non-IP network traffic, such as DHCP requests or ARP messages, from being compromised and used to attack the network.

In a typical wired enterprise network, MAC-level messages between devices on a local network are contained within the walls of the enterprise. Routers form the boundary for Ethernet segments and block MAC traffic from the outside world.

Wireless networks, however, are different. Wireless access points act as simple MAC-layer bridges, transmitting MAC frames to and from the wired network. Attackers can learn a significant amount of detail about the nature of traffic on both the wireless and wired network by simply observing radio traffic and sniffing IP addresses, protocols in use, and other information available in an unprotected IP header. Worse, attackers can exploit non-IP protocols to deny service or compromise the network.

Because SafeConnect encrypts completed frames before they are transmitted, all traffic, including the “unseen” protocols like ARP and DHCP, are fully authenticated and authorized. An attacker viewing traffic on a wireless network protected by SafeConnect will not see information of any interest and will not be able to inject traffic of any kind onto the wired network.

7. End Sessions

All SafeConnect sessions expire after an administrator-defined period of time that you can configure per policy. Before a session expires, SafeConnect prompts the user to provide authentication credentials so the session can continue without interruption.

Ten minutes before the session is scheduled to end, the Client sends an EAPoL “Hello” message to initiate the re-authentication process. If the user is not available to provide credentials, the session expires on all Access Controllers simultaneously, and SafeConnect erases all session keys.

1. A method for simultaneous connection of a network device to a virtual private network (VPN) and a non virtual private network (non-VPN) using a single network interface comprising steps of:
assigning a first IP address to said network interface, said first IP address for identifying said network device on said VPN;
assigning a second IP address to said network interface, said second IP address for identifying said network device on said non-VPN;
receiving a hardware address request for said first IP address, and in response thereto sending a hardware address of said network interface, but only if said hardware address request originates from a device on said VPN; and
receiving a hardware address request for said second IP address that originates from a device on said non-VPN, and in response thereto sending a hardware address of said network interface.

2. The method of claim 1 further including disregarding a message, received from a device on said non-VPN, that indicates a mapping of a given IP address to a given hardware address, whereby said network device will not send any packets destined for said given IP address to said given hardware address.

3. The method of claim 2 wherein said message is an ARP request or an unsolicited neighbor advertisement.

4. The method of claim 1 further comprising authenticating said hardware address request for said first IP address.

5. The method of claim 4 wherein authentication is not performed on said hardware address request for said second IP address.

6. The method of claim 1 further comprising receiving a message that indicates a mapping of a given IP address to a given hardware address, wherein said network device will send packets destined for said given IP address to said given hardware address, but only if said message originated from a device on said VPN.

7. The method of claim 1 wherein said hardware address of said network interface is the media access control (MAC) address assigned to said network interface.

8. The method of claim 1 wherein the claimed steps are performed by said network device.

9. A method for simultaneous connection of a network device to a virtual private network (VPN) and a non virtual private network (non-VPN) using a single network interface comprising steps of:
receiving a message indicative of a mapping between a first given IP address and a first given hardware address, wherein said network device will send packets destined for said first given IP address to said first given hardware address, but only if said message originated from a device on said VPN; and
receiving a message from a device on said non-VPN indicative of a mapping between a second given IP address and a second given hardware address, wherein said message from said device on said non-VPN is ignored and any packets destined for said second given IP address will not be sent to said second given hardware address.

10. The method of claim 9 further comprising:
assigning a first IP address to said network interface, said first IP address for identifying said network device on said VPN;
assigning a second IP address to said network interface, said second IP address for identifying said network device on said non-VPN;
receiving a hardware address request for said first IP address, and in response thereto sending a hardware address of said network interface, but only if said hardware address request originates from a device on said VPN; and
receiving a hardware address request for said second IP address that originates from a device on said non-VPN, and in response thereto sending a hardware address of said network interface.

11. The method of claim 9 wherein said first given hardware address is the MAC address assigned to a device on said VPN.

12. The method of claim 11 wherein said second given hardware address is the MAC address assigned to a device on said non-VPN.

13. The method of claim 9 wherein said steps are performed by said network device.

14. A computer system configured to provide simultaneous connection to a VPN and to a non-VPN from a single network interface comprising:
a network interface for connection to a network, said network interface having a hardware address,
wherein said computer system is configured to:
assign a first IP address to said network interface, said first IP address for identifying said computer system on said VPN;
assign a second IP address to said network interface, said second IP address for identifying said computer system on said non-VPN;
receive a hardware address request for said first IP address, and in response thereto send a hardware address of said network interface, but only if said hardware address request originates from a device on said VPN; and
receive a hardware address request for said second IP address that originates from a device on said non-VPN, and in response thereto sending a hardware address of said network interface.

15. The computer system of claim 14 wherein the computer system is further configured to disregard a message, received from a device on said non-VPN, indicative of a mapping between a given IP address and a given hardware address, whereby said computer system will not send any packets destined for said given IP address to said given hardware address.

16. The computer system of claim 14 wherein the computer system is further configured to receive a message indicative of a mapping between a given IP address and a given hardware address, whereby said computer system will send packets destined for said given IP address to said given hardware address, but only if said message originated from a device on said VPN.

17. The computer system of claim 14 wherein said hardware address of said network interface is sent to said device on said VPN in response to receiving said hardware address request for said first IP address.

18. The computer system of claim 17 wherein said hardware address of said network interface is sent to said device on said non-VPN in response to receiving said hardware address request for said second IP address.

19. A method in a computer for simultaneous connection of said computer to a VPN and a non-VPN via a single network interface comprising steps of:
providing program executable code that is executed by said computer,
said program executable code operating said computer to:
assign a first IP address to said network interface, said first IP address for identifying said computer on said VPN;
assign a second IP address to said network interface, said second IP address for identifying said computer on said non-VPN;
receive a hardware address request for said first IP address, and in response thereto send a hardware address of said network interface, but only if said hardware address request originates from a device on said VPN; and
receive a hardware address request for said second IP address that originates from a device on said non-VPN, and in response thereto sending a hardware address of said network interface.

20. The computer system of claim 19 further including said program executable code operating said computer to disregard a message, received from a device on said non-VPN, indicative of a mapping of a given IP address to a given hardware address, whereby said computer will not send any packets destined for said given IP address to said given hardware address.

21. The computer system of claim 19 wherein further including said program executable code operating said computer to receive a message indicative of a mapping of a given IP address to a given hardware address, whereby said computer will send packets destined for said given IP address to said given hardware address, but only if said message originated from a device on said VPN.
